(19) United States
(12) Patent Application Publication
(10) Pub. No.: US 2012/0177468 A1
(43) Pub. Date: Jul. 12, 2012

(54) FOLDING TABLE TRANSPORTATION AND STORAGE SYSTEM

(75) Inventor: Christopher C. DICKEY, West St. Paul, MN (US)

(73) Assignee: Sico Incorporated, Edina, MN (US)

(21) Appl. No.: 13/292,641

(22) Filed: Nov. 9, 2011

Related U.S. Application Data
(60) Provisional application No. 61/412,095, filed on Nov. 10, 2010.

(51) Int. Cl. B60P 1/43

(52) U.S. Cl. 414/537; 414/812

(57) ABSTRACT

A table transport and storage system includes a frame supported on casters. The system includes supports for retaining folded tables in a substantially vertical orientation. A loading ramp is movable between a raised position for transport and a lowered position for loading and unloading. A lock assembly automatically locks the ramp at a lowered position and a spring biases the ramp toward the raised position in one embodiment. A releasable brake automatically engages one or more of the casters when the ramp is lowered to keep the system from moving during loading and unloading of the tables. A lever releases the ramp and the brakes.

### BACKGROUND

1. Field of the Invention

The present invention relates to an apparatus for transporting and storing folding tables, such as round folding tables, and to a method for loading and unloading the tables from the storage apparatus.

2. Prior Art

Caddies for moving folding tables are well-known. Folding tables are used extensively in multi-use spaces such as hotel ballrooms, banquet facilities, convention halls, and other similar spaces. Round or oval tables are often preferred to provide a warmer, more intimate seating configuration. For multi-use facilities, it is important that the tables are able to be quickly and easily set up and taken down, and easily transported to a storage location. Moreover, it should be appreciated that moving such tables can be a labor and time intensive activity.

Caddies may be rolled from place to place and provide transport of multiple tables to decrease the time and effort required to move tables from location to location. Caddies have been developed that store these tables with the tabletops oriented substantially vertically and provide a degree of nesting to accommodate a greater number of tables and to decrease the size of the caddy. Such caddies are also used as storage devices for round or oval folding tables.

Although such table caddies are an improvement over moving the tables individually, the caddies have several problems. Loading and unloading such caddies is a challenging task.

The caddies typically have swivel-mounted casters that may need to be locked or the caddy must be held by a worker in order to prevent the caddy from rolling away while tables are slid and rolled onto caddy. The engagement of typical caster locks requires workers to bend down or trying to engage the lock on a caster with a worker's foot. The caster may swivel, leading to difficulties in easily moving the locking device to engage the caster with one hand or a foot. Caddies have been developed with ramps that allow for rolling the tables upward and onto the caddy and into the storage rack. If the caddy is not locked, rolling the tables onto the caddy or sliding the tables along the caddy may result in the caddy simply being pushed by the table moving so that the table does not roll onto the ramp. The ramp may still require that the tables be lifted slightly onto the ramp and depending upon the angle of the ramp, may still require that casters be locked in order to prevent the caddy from rolling away from the table. To overcome the problems of lifting the table onto a ramp, the bottom edge of the ramp may be positioned so that a lowermost edge is proximate the floor. However, such a configuration leads to additional challenges and difficulties related to clearance and to movement over uneven surfaces. Even with a lower edge near the floor, the table may still push the caddy and not roll onto the ramp if the casters are not locked.

In addition, conventional table caddies may require reconfiguration of the entire frame to accommodate different size tables or may not be adaptable to tables of different sizes, such as may be used at multi-use facilities.

It can be seen that a new and improved table transport and storage system is needed. Such a system should provide for easily and automatically locking the casters of the caddy to prevent the caddy from moving away from workers when tables are being loaded and unloaded. Moreover, such a system should provide a ramp that facilitates easy movement from the floor to a storage space. Such a ramp should be movable so that it does not drag on the floor during transportation. In addition, such a caddy should provide for easily engaging and disengaging the lock and ramp. Such caddies would also be advantageous if they could easily adapt to different sized tables. The present invention addresses these as well as other problems associated with folding table transport and storage systems.

### SUMMARY OF THE INVENTION

The present invention is directed to a transport and storage system for folding tables. The folding table transport and storage system is used to transport generally round or oval tables that have legs that fold to an underside of the table for storage. Tables may be rolled along their edges. However, for transporting larger numbers of tables and for storage, it is helpful to have a caddy system that supports multiple tables for transport and allows the tables to be organized and stored in an upright position with a degree of nesting to minimize the amount of storage space required.

The caddy system includes a framework that mounts on casters for easily moving from location to location. The framework has lower table support elements mounted to support lower edges of the table. Slots at the front of the caddy receive forward edges of the tables and maintain the tabletops in a substantially vertical position.

A movable ramp system is lowered for loading and unloading, and is raised above the floor to provide sufficient clearance during transport. The ramp includes a spring to urge the ramp toward the raised position, and a lock to maintain the ramp in the lowered position. The lock includes a lever mounted to extend from the lower portion of the frame so that it can be easily tripped by hand or with a worker's foot. The lock is mounted with a center of gravity that causes it to move to a position to maintain the ramp at the lowered position against the force of the spring pushing upward on the ramp. The lever includes a hook portion that engages a pin mounted to the ramp. The hook portion engages the pin when the ramp is in the raised position, while the pin is below the hook and engages a lower edge of the lever when the ramp is in the lowered position. The pivot location, weight and center of gravity of the lever cause the lever to rotate about its pivot pin to move to the engaged position to hold the ramp at the lowered position.

The ramp also includes a braking assembly that engages the rear casters to maintain the caddy system at a stationary position so that the caddy does not move away while trying to move the tables up or down the ramp. The brake members that are pivotally mounted to the ramp are biased to engage the casters when the ramp is lowered. The pivot location and range of motion are such that the brake engagement members automatically move away from the casters and are disengaged when the ramp is raised.

The ramp system provides for easily rolling the tables and automatically lowering the ramp and locking the casters by simply pushing the ramp downward. In addition, by simply tripping the lever, the ramp is moved to a raised position and the brakes are automatically disengaged. Loading can be easily accomplished by simply rolling the tables up and down the ramp into the storage area formed by the support members. The system is also easily adaptable by moving the alignment rack to various positions to accommodate different diameter tables. The alignment rack has slots that engage the front edges of the tables and maintains the tables in the proper location in the storage area and maintains the tables oriented in a substantially vertical plane.

These features of novelty and various other advantages that characterize the invention are pointed out with particularity in the claims annexed hereto and forming a part hereof However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE FIGURES

Referring now to the drawings, wherein like reference numerals and letters indicate corresponding structure throughout the several views:

FIG. 1 is a perspective view of a table transport and storage system according to the principles of the present invention;

FIG. 2 is a side elevational view of the table transport and storage system shown in FIG. 1 in a transport configuration with the ramp raised;

FIG. 3 is a side elevational view of the table transport and storage system shown in FIG. 1 in a loading configuration with the ramp lowered;

FIG. 4 is a top plan view of the table transport and storage system shown in FIG. 1;

FIG. 5 is a bottom plan view of the table transport and storage system shown in FIG. 1;

FIG. 6 is a sectional view of the table and transport system taken a centerline of FIG. 2;

FIG. 7 is a sectional view of the table and transport system taken along a centerline of FIG. 3 with the ramp in a lowered position;

FIG. 8 is a detail sectional view of the table and transport system taken through the lock device shown in FIG. 2;

FIG. 9 is a detail sectional view of the table and transport system taken through the lock device shown in FIG. 3;

FIG. 10 is a perspective view of the table transport and storage system shown in FIG. 1 with a front table support moved to a second position; and

FIG. 11 is a top plan view of the table transport and storage system shown in FIG. 10.

### DETAILED DESCRIPTION OF THE PREFERRED EMBODIMENT(S)

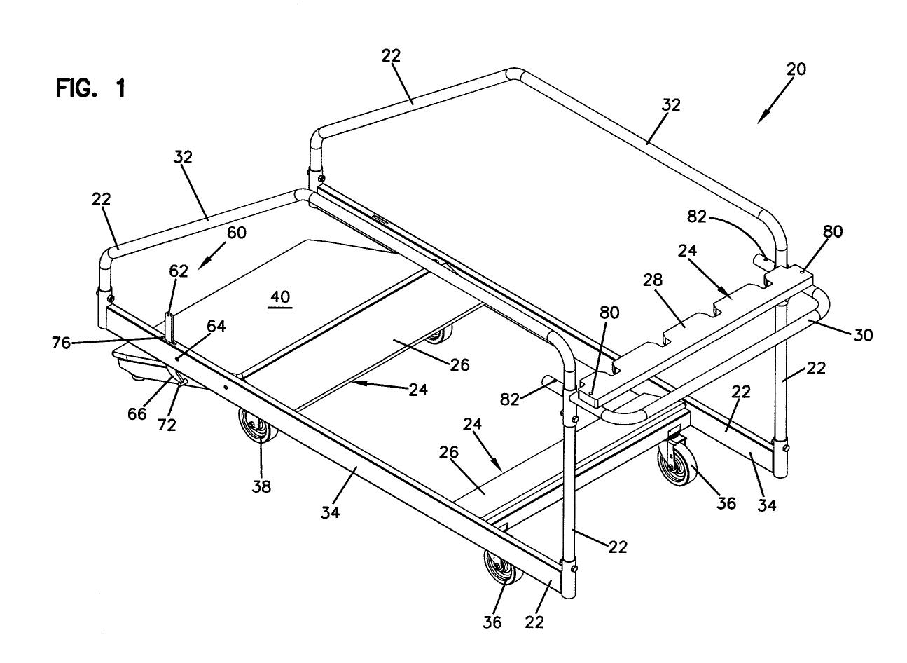

Referring now to the drawings and in particular to FIG. 1, there is shown a table transport and storage system, generally designated 20. Such systems 20 are more commonly referred to as a table caddy. The caddy 20 is generally configured to store round or oval folding tables with the tabletops oriented in a generally vertical position, and with the tabletops placed back-to-back to provide a degree of nesting, therefore decreasing the space required for storage. The caddy 20 includes a frame 22 having an upper frame 32 and a lower frame 34. The lower frame 34 is supported on two front casters 36 and two rear casters 38. In the embodiment shown, the front casters 36 are mounted so as to swivel to provide for easier maneuvering, while the rear casters 38 are not mounted to swivel. The upper frame 32 defines a side and front framework while providing access to the rear of the caddy 20 for loading and unloading tables. A handle 30 mounts at the front of the caddy 20 to provide for easily pushing or pulling the caddy and maneuvering the caddy 20 into position for loading, unloading, and storage.

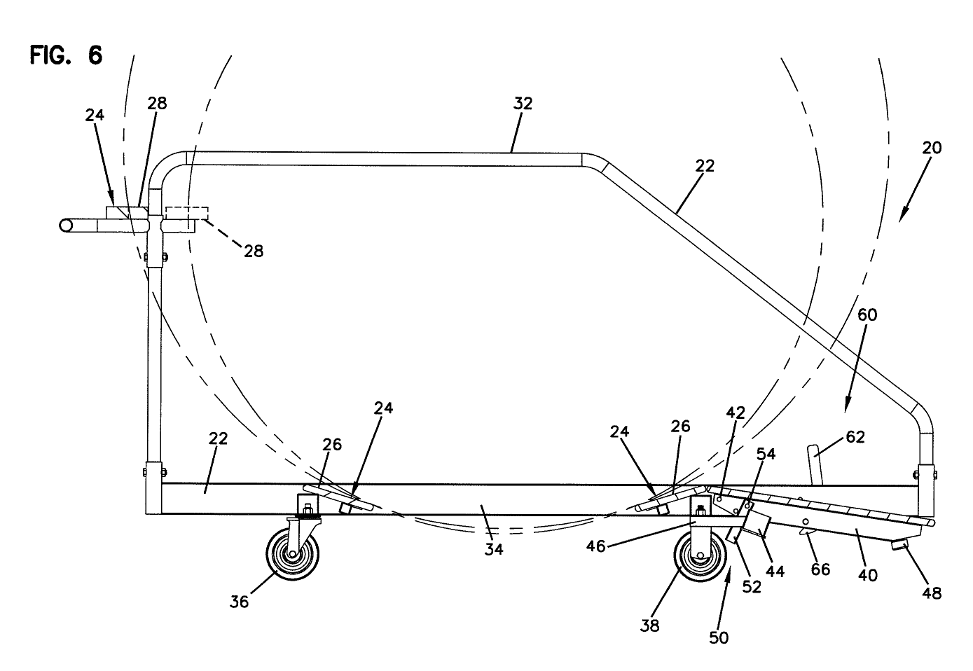

As shown most clearly in FIGS. 1, 3, and 6, the caddy 20 includes a table storage assembly 24 including angled lower supports 26 and a front rack 28. The lower supports 26 are angled to provide a base on either side of the lowermost point of a stored round table forming a cradle to receive the tables. A front rack 28 is adjustably mounted to the frame 22 and includes slots for receiving and retaining edges of the tabletops. The rack 28 is preferably positioned such that the edges of the tables fit into the slots when the tables are supported on the lowermost supports 26, as shown in FIG. 6. When the rack 28 is moved forward or rearward, it accommodates tables (shown in phantom) of different sizes to ensure that the tables rest on both of the lowermost supports 26.

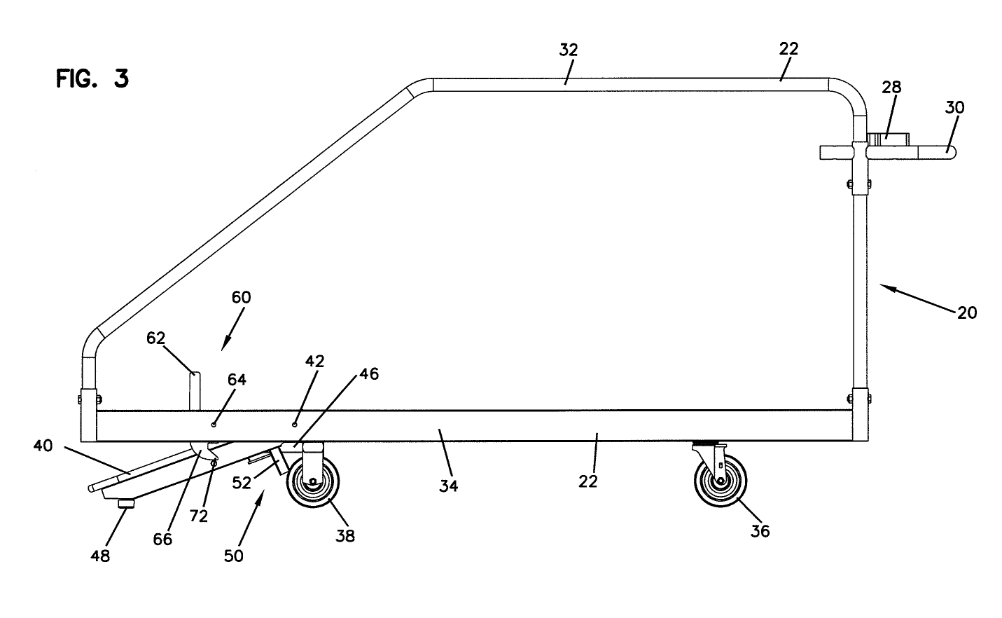

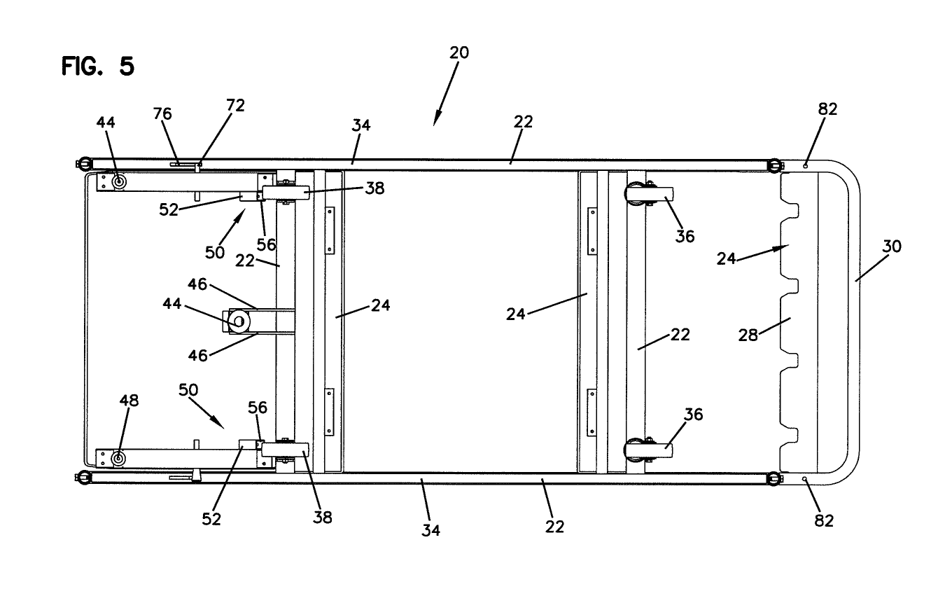

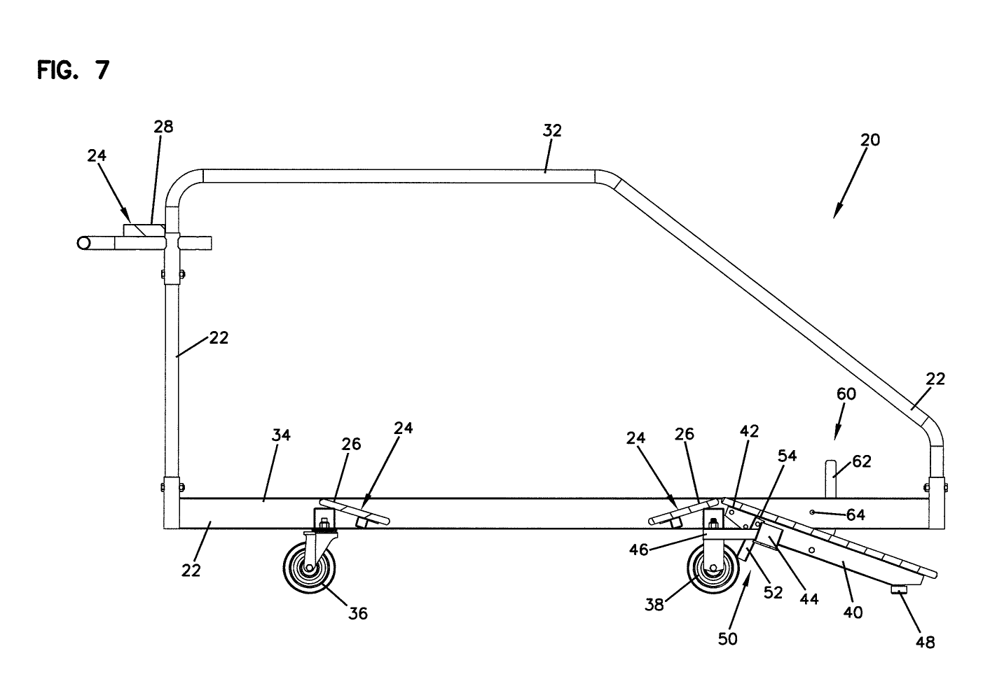

Referring to FIGS. 1, 3, and 5-7, the caddy 20 includes a movable ramp assembly 40. The ramp 40 includes pads 48 to engage the ground in a lowered position. The ramp 40 is moved between a lowered position shown in FIGS. 3 and 7 for loading and unloading, and a raised storage position shown in FIG. 6. The movable ramp provides for easier loading and unloading of the tables so that the tables do not need to be lifted up and onto the ramp 40. The ramp 40 also includes a spring 44, shown most clearly in FIG. 5, having a relatively high spring constant that biases the ramp 40 toward the raised transport position. A lock assembly 60 maintains the ramp 40 in the lowered position for loading an unloading the tables, as explained hereinafter.

As shown in FIGS. 5-7, the caddy 20 also includes a brake assembly 50. The brake assembly 50 automatically engages when the ramp 40 is lowered to prevent the rear casters 38 from rotating. This maintains the caddy system 20 in a stationary position so that the caddy 20 does not roll away while the tables first engage the lower end of the ramp. In this manner, the caddy system 20 does not need to be held, and the locks do not need to be manually engaged, which would be difficult with swivel-mounted casters. The brake assembly includes engagement members 52 that automatically are pressed against the outer periphery of each of the rear casters 38. Each of the engagement members mounts on a pivot 54, and includes an associated biasing spring 56 that maintains the corresponding engagement member 52 in contact with its rear caster 38. The springs 56 ensure that both of the engagement members 52 maintain contact with the associated rear casters 38 and overcome minor differences due to tolerances that might otherwise affect the contact force being maintained by the both engagement members 52 against the rear casters 38. When the ramp 40 is raised, the engagement members 52 rotate about the pivot 54 and are automatically moved away from engagement with the rear casters 38 so that the casters 38 freely rotate and the caddy system 20 may be freely moved.

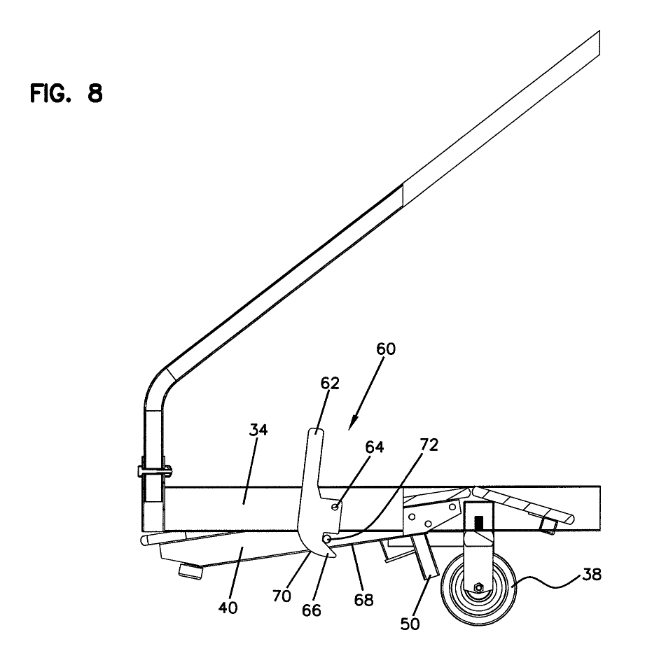

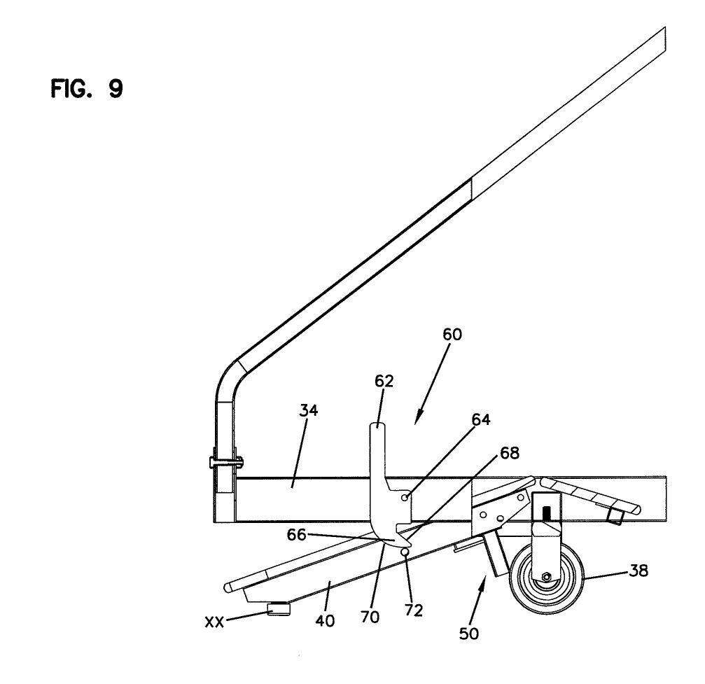

The lock assembly 60, most clearly shown in FIGS. 8 and 9, is housed in a longitudinal lower frame member 34. The lock assembly includes a lever 62 extending upward through a slot 76 in the upper surface of the frame member 34. The lever 62 may be easily actuated by simply pushing the lever 62 to disengage from the locked position. The lever 62 is mounted on a pivot 64, and includes a lower hook portion 66 extending downward below the pivot 64 and below the frame member 34. In the locked position, the hook 66 is configured to engage a pin 72 mounted to the ramp 40. The lever 62 is pivotally mounted and has a center of gravity that causes it to move toward a position that maintains the lock assembly in the engaged locked position. The hook portion 66 has a curved upper surface 68 and a curved underside 70. When the ramp 40 is in the lowered position and the lock 60 is engaged, the underside 70 of the hook portion 66 engages the top of the pin 72, which is pushed upward against the underside 70 by the force of the spring 44 pushing upward against the ramp 40. When the lever 62 is actuated to push the hook portion 66 away from the pin 72 and release the lock assembly 60, the spring 44 forces the ramp 40 upward, and the hook 66 pivots so that the pin 72 passes around the end of the hook 66. The upper surface 68 of the hook portion 66 slides along the pin 72 until the pin 72 fits into a notch formed in the hook portion 66. The spring 44 along with the geometry of the lever 62 and gravity provide for retaining the ramp 40 in the raised position. When the ramp 40 is pushed downward, the upper surface 68 of the hook portion 66 slides along the pin 72 with the tip of the hook 66 moving around the pin 72 due to the location of the pivot 64 and the its center of gravity to again engage the underside 70 of the hook portion 66 and maintain the ramp 40 in the lowered position.

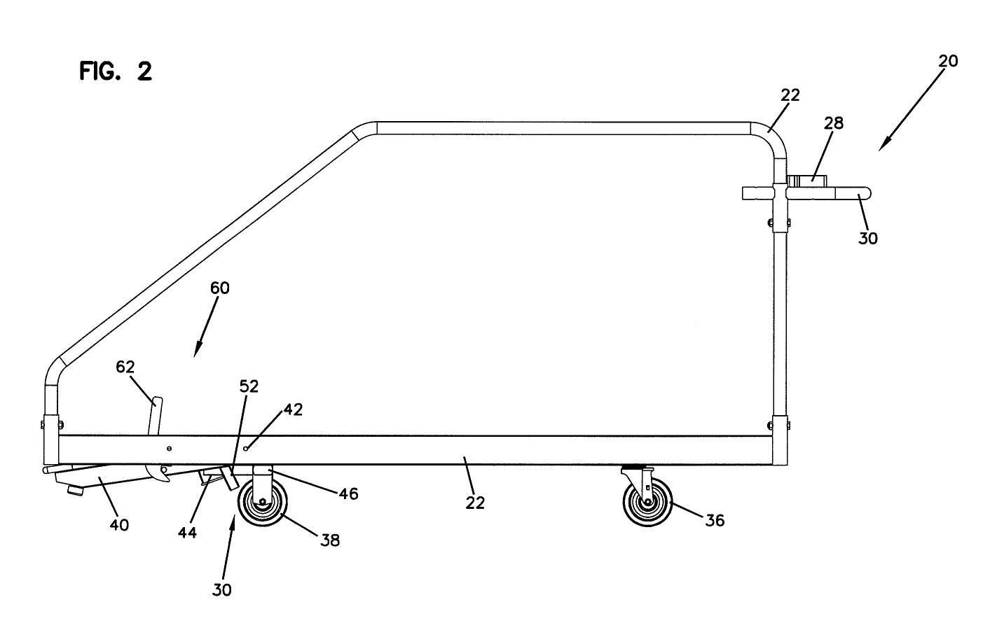

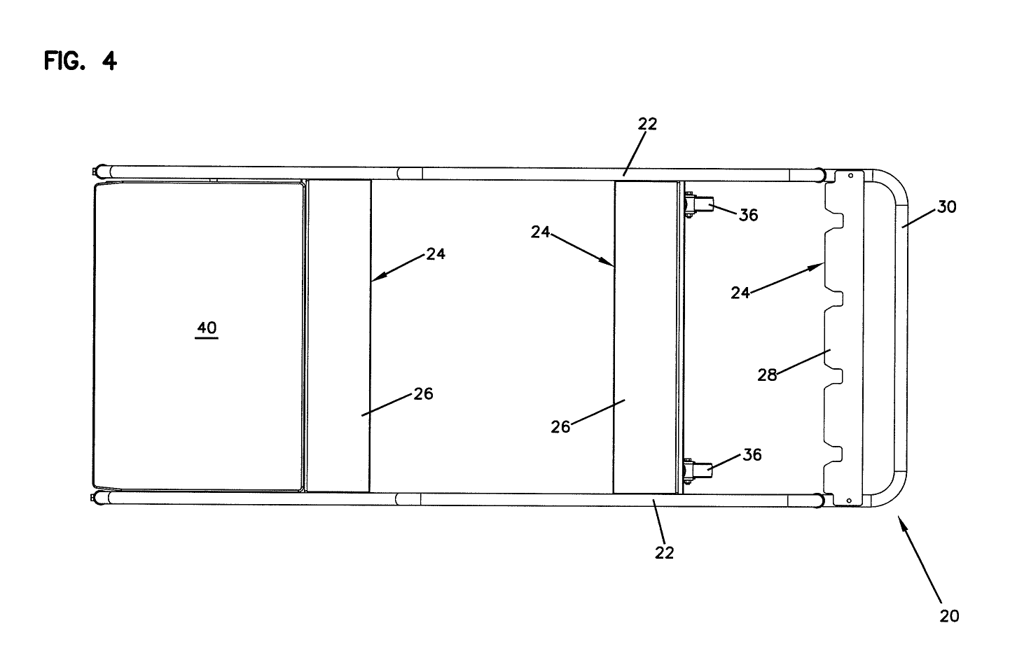

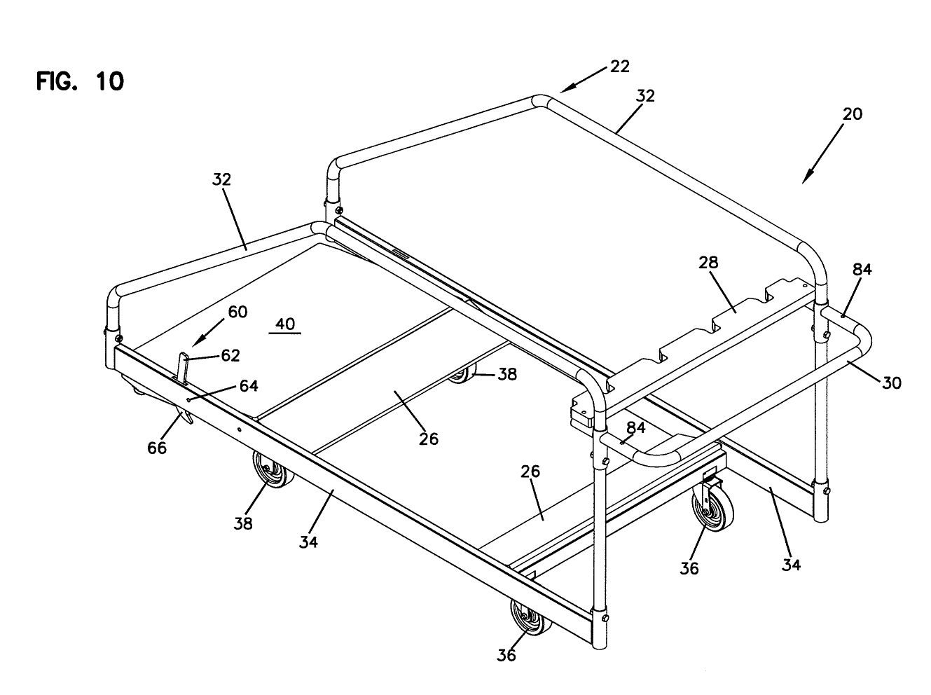

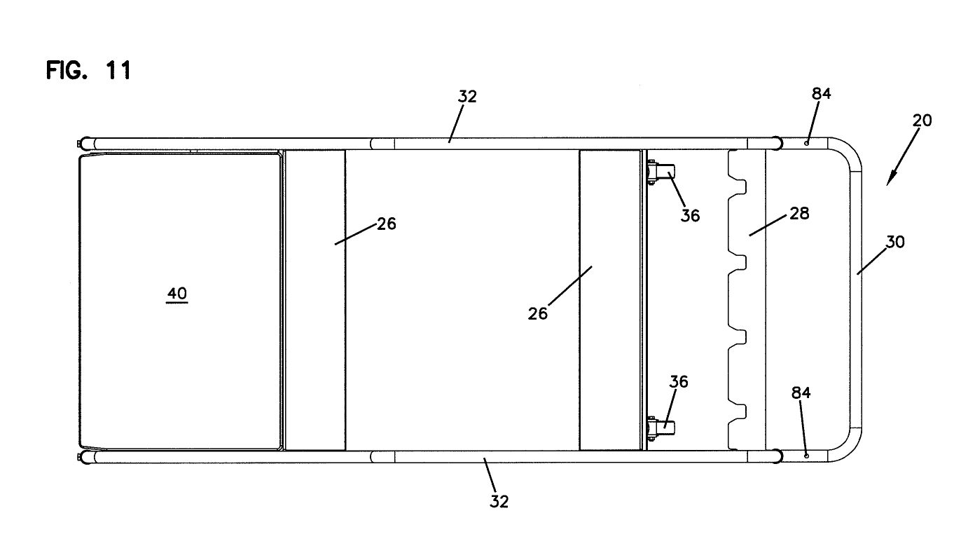

Referring now to FIGS. 10 and 11, it can be seen that the caddy 20 is adjustable to accommodate tables of different diameters. The rack 28 is adjustably mounted to accommodate different diameter tables. Removable cotter pins or other pins 80 provide for moving between the position shown in FIGS. 1-9 and that in FIGS. 10 and 11. The rack 28 is mountable in first mounting holes 82 to the rear of the forward upright of the frame 22, or in second mounting holes 84 in the handle 30 and in front of the front-most upright of the frame 22. It can further be appreciated that the angle and/or position of the lower support members 26 might also be moved or adjusted to closely fit and support the edges of the tables being stored.

Loading and unloading of the tables is a simple procedure with the caddy 20. For loading, the ramp 40 is lowered by simply pushing it downward to the position shown in FIGS. 3 and 7. When the ramp 40 is lowered, the rear casters 38 are automatically locked to maintain the caddy 20 in a stationary position. The round tables may then be rolled on their edge to the lower end of the ramp 40 and rolled up the ramp over the cross-members in the lower frame 34 until resting between the front and rear lower supports 26. The edges of the folding tables are aligned and retained in the slots in the front rack 28. When the caddy 20 is full, or when all the tables have been loaded, the lever 62 is then pushed forward to release the lock assembly 60. The ramp 40 is automatically pushed upward by the spring 44 into the raised position so that the pads 48 do not drag on the ground. Raising the ramp 40 also releases the brake assembly 50 so that the rear casters 38 freely rotate and the caddy may be freely pushed or pulled to any desired location.

In a similar manner, unloading of the table transport and storage system 20 is just a reversal of the steps of loading. The ramp 20 is again lowered to its position shown in FIGS. 3 and 7, thereby also engaging the brake assembly 50 and locking the rear casters 38. The tables are simply rolled from the stored position up over the cross-member in the lower frame 34, and rolled down the ramp 40 to the desired location for unfolding and setting up.

It can be appreciated that the caddy system 20 of the present invention provides for safe, simple, and automatic positioning of the loading and unloading elements. The system 20 includes a ramp 40 that moves up and down for a more advantageous loading and unloading position, as well as an advantageous transport position. Moreover, the system 20 automatically engages and locks the casters 38 to prevent the caddy from moving during loading and unloading. By simply tripping the lever 62, the brakes 50 are released and the ramp is automatically raised to a transport position. The system 20 also provides for adjusting the table support elements to accommodate different diameter tables, without requiring additional parts for reconfiguring the frame.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A table transport and storage apparatus, comprising:
a frame;
a plurality of rolling elements supporting the frame;
a table support; and
a ramp movable between a first position and a second position.

2. A table transport and storage apparatus according to claim 1, further comprising a lock to lock the ramp at the first position or the second position.

3. A table transport and storage apparatus according to claim 1, further comprising a brake preventing rolling of at least one of the rolling elements.

4. A table transport and storage apparatus according to claim 3, further comprising a brake release.

5. A table transport and storage apparatus according to claim 3, further comprising a biasing element maintaining the brake in contact with the at least one of the rolling elements.

6. A table transport and storage apparatus according to claim 1, further comprising a spring biasing the ramp toward the first position or the second position.

7. A table transport and storage apparatus, comprising:
a frame defining a storage space for a plurality of tables;
a table support configured to hold and align a plurality of tables with the tabletops in a substantially vertical orientation;
a ramp movable between a first position, and a second position configured to roll the tables onto the table support;
rolling elements mounted to the frame; and
a brake configured to engage and to brake at least one of the rolling elements when the ramp is at the second position.

8. A table transport and storage apparatus according to claim 7, further comprising a spring biasing the ramp toward the first position.

9. A table transport and storage apparatus according to claim 7, further comprising a lock locking the ramp at the second position

10. A table transport and storage apparatus according to claim 9, further comprising a release releasing the lock from the engaged position

11. A table transport and storage apparatus according to claim 7, further comprising a brake engagement mechanism biasing the engagement mechanism toward engagement of the at least one of the rolling elements.

12. A table transport and storage apparatus according to claim 9, wherein the lock is housed in a portion of the frame.

13. A table transport and storage apparatus according to claim 12, wherein the lock includes a release lever extending from the portion of the frame.

14. A table transport and storage apparatus according to claim 12, wherein the lock includes a hook connected to the release lever and engaging a pin mounted to the ramp

15. A table transport and storage apparatus according to claim 7, wherein the rolling elements comprises two fixed rolling casters and the brakes engages at lest one of the fixed casters.

16. A table transport and storage apparatus according to claim 7, wherein the table support comprises a rack configured for engaging edges of the tabletops.

17. A table transport and storage apparatus according to claim 16, wherein the rack is movable to engage tabletops having different sizes.

18. A method of transporting a table with a table transport, the table transport including a frame, rolling elements, a brake to engage one of the rolling elements, a table support assembly, and a ramp movable between a first position and a second position and a second position configured to roll the table onto the table transport, the method comprising:
applying the brake to engage one of the rolling elements;
lowering the ramp from the first position to the second position;
rolling the table up the ramp and into the table support assembly;
moving the ramp from the second position to the first position;
releasing the brake;
moving the table transport with the table to a desired location.

19. A method according to claim 18, further comprising rolling a plurality of tables into the table support assembly and moving the table transport with the plurality of tables to a desired location.

20. A method according to claim 18, wherein the table has a substantially round table top.
